(19) United States
(12) Patent Application Publication
(10) Pub. No.: US 2026/0294094 A1
(43) Pub. Date: Oct. 1, 2026

(54) KEYBOARD SUPPORT PANEL DEVICE

(71) Applicant: Bryant Nguyen, Los Alamitos, CA (US)

(72) Inventor: Bryant Nguyen, Los Alamitos, CA (US)

(21) Appl. No.: 19/097,005

(22) Filed: Apr. 1, 2025

(51) Int. Cl. F16M 11/14; A47B 21/03; F16M 11/20; F16M 13/02

(52) U.S. Cl. CPC A47B 21/0314; A47B 2021/0321; A47B 2021/0335; F16M 11/14; F16M 11/2064; F16M 13/022

(57) ABSTRACT

A keyboard support panel device includes a plate having a first component and a second component. The first component is selectively disconnectable from the second component. A first adjustable arm has a first end coupled to the first component. A first clamp is coupled to a second end of the first adjustable arm. A second adjustable arm has a primary end coupled to the second component. A second clamp is coupled to a secondary end of the second adjustable arm.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to keyboard support panel device and more particularly pertains to a new keyboard support panel device for providing adjustable support to a single piece or two piece keyboard.

### (2) Description of Related Art Including Information Disclosed Under 37 CFR 1.97 and 1.98

The prior art relates to keyboard support panel devices. Known prior art lacks adjustable support of a one or two piece keyboard.

### (h) BRIEF SUMMARY OF THE INVENTION

An embodiment of the disclosure meets the needs presented above by generally comprising a plate having a first component and a second component. The first component is selectively disconnectable from the second component. A first adjustable arm has a first end coupled to the first component. A first clamp is coupled to a second end of the first adjustable arm. A second adjustable arm has a primary end coupled to the second component. A second clamp is coupled to a secondary end of the second adjustable arm.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front side perspective view of a keyboard support panel device according to an embodiment of the disclosure.

FIG. 2 is a top front side perspective view of an embodiment of the disclosure in a split position.

FIG. 3 is a side view of an embodiment of the disclosure.

FIG. 4 is a top view of an embodiment of the disclosure.

FIG. 5 is a front view of an embodiment of the disclosure.

FIG. 6 is a top view of an embodiment of the disclosure in use.

### (j) DETAILED DESCRIPTION OF THE INVENTION

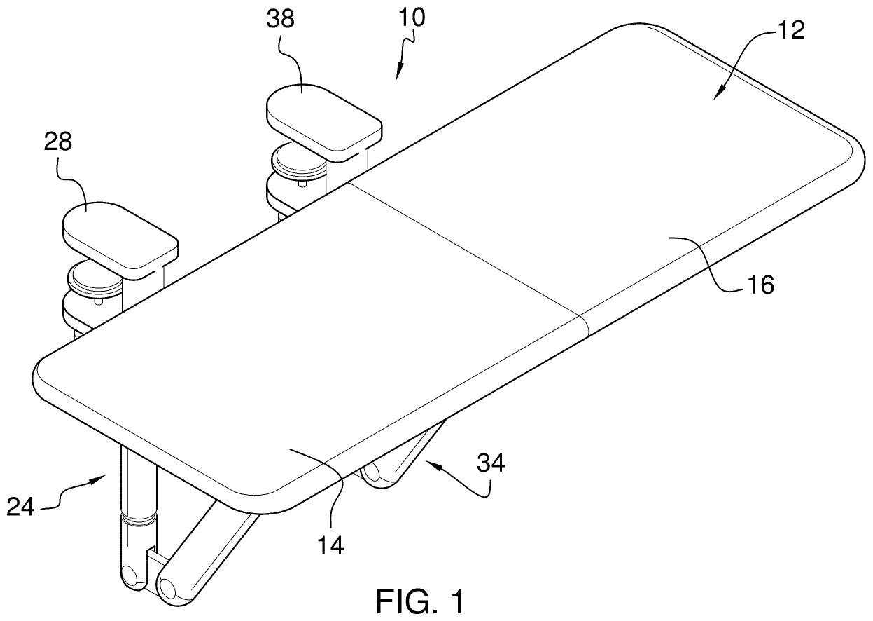

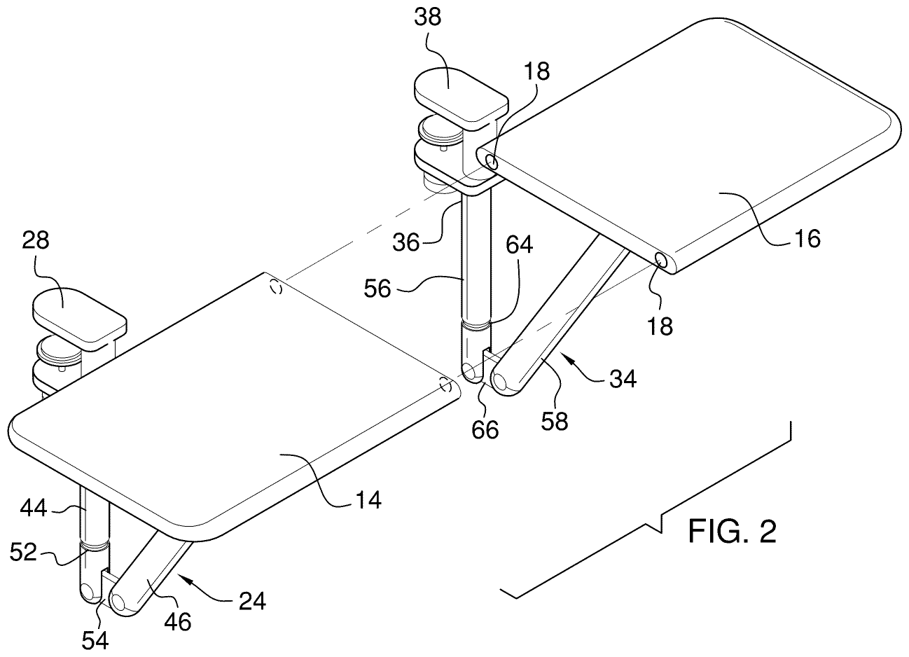

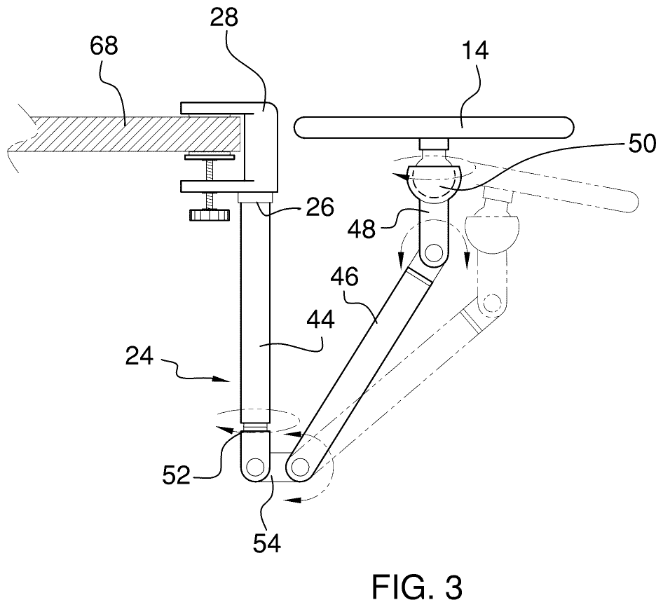

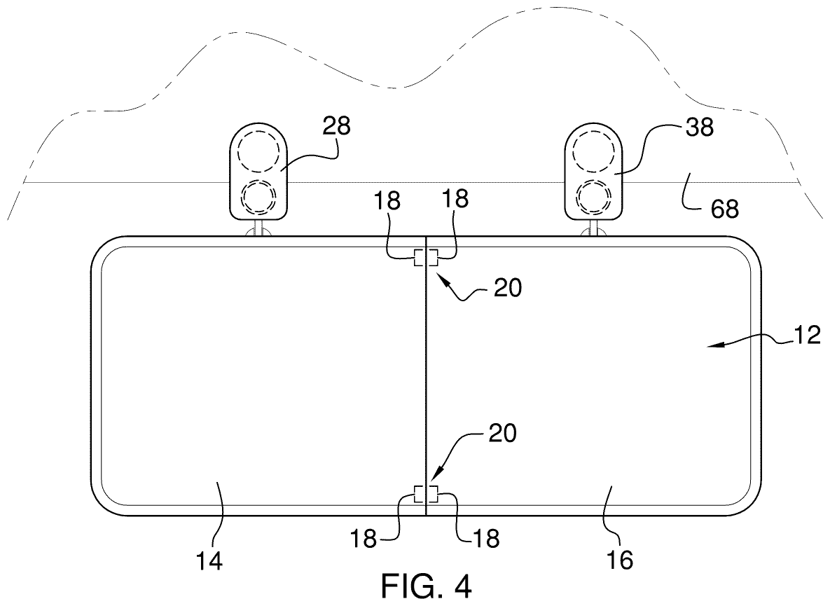

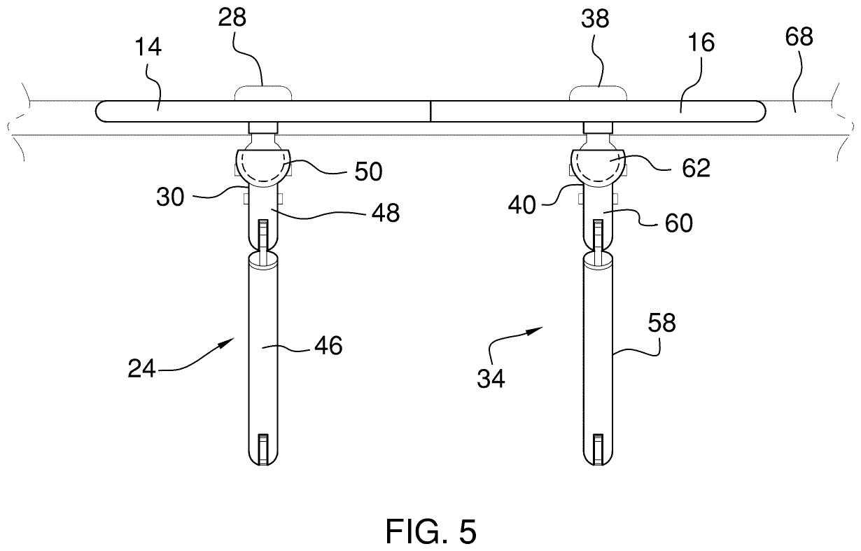

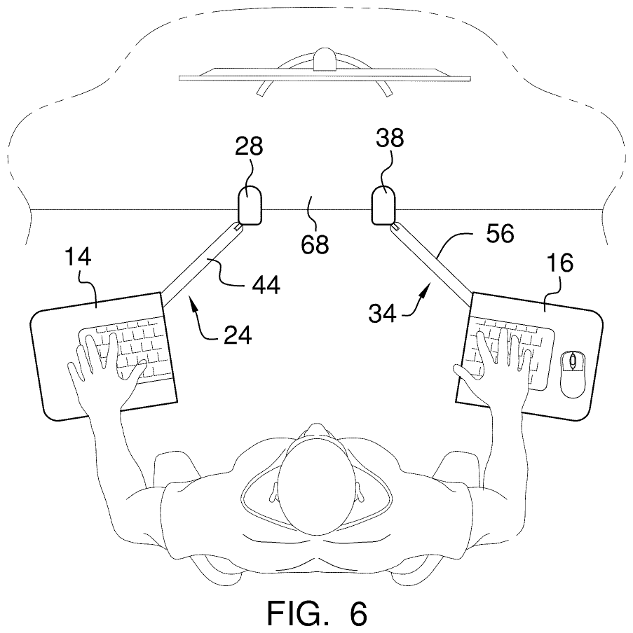

With reference now to the drawings, and in particular to FIGS. 1 through 6 thereof, a new keyboard support panel device embodying the principles and concepts of an embodiment of the disclosure and generally designated by the reference numeral 10 will be described.

As best illustrated in FIGS. 1 through 6, the keyboard support panel device 10 generally comprises a plate 12 having a first component 14 and a second component 16. The first component 14 is selectively disconnectable from the second component 16. Each of a plurality of magnets 18 is positioned in the plate 12. The magnets 18 releasably couple the first component 14 to the second component 16. The magnets 18 may be distributed in opposed pairs 20 on abutting planar edges 22 of each of the first component 14 and second component 16.

A first adjustable arm 24 has a first end 26 coupled to the first component 14. A first clamp 28 is coupled to a second end 30 of the first adjustable arm 24. A second adjustable arm 34 has a primary end 36 coupled to the second component 16. A second clamp 38 is coupled to a secondary end 40 of the second adjustable arm 34.

The first adjustable arm 24 includes a first segment 44 coupled to and extending from the first clamp 28. A second segment 46 of the first adjustable arm is pivotable relative to the first segment 44. A third segment 48 of the first adjustable arm 24 is pivotable relative to the second segment 46. A first arm ball joint 50 is coupled to the third segment 48 and the first component 14 of the plate 12. A first arm swivel joint 52 is positioned in the first segment 44. The first arm swivel joint 52 is positioned adjacent to the second segment 46. The first segment 44 is pivotably coupled to a first arm pivot plate 54. The second segment 46 is also pivotably coupled to the first arm pivot plate 54.

The second adjustable arm 34 includes a first section 56 coupled to and extending from the second clamp 38. A second section 58 is pivotable relative to the first section 56. A third section 60 is pivotable relative to the second section 58. A second arm ball joint 62 is coupled to the third section 60 and the second component 16 of the plate 12. A first arm swivel joint 64 is positioned in the first section 56. The first arm swivel joint 64 is positioned adjacent to the second section 58. The first section 56 is pivotably coupled to a second arm pivot plate 66 and the second section 58 is also pivotably coupled to the second arm pivot plate 66. Connections within the first adjustable arm 24 and the second adjustable arm 34 may be sufficiently tight to allow for adjustment but to hold a static position once adjusted into a desired position and to support the weight of a keyboard on the plate 12. Alternatively, conventional tightening mechanisms may be incorporated to help secure each of the first adjustable arm 24 and second adjustable arm 34 into a desired position. Further, the first component 14 may be separated from the second component 16 and each independently adjusted to a desired position. Thus, the first component 14 may support a part of a keyboard and the second component 16 can support a second part of the keyboard.

In use, the first clamp 28 and second clamp 38 are attached to a support structure 68 such as a desktop. The plate 12 is positionable as desired relative to the support structure 68 by adjusting the first adjustable arm 24 and the second adjustable arm 34. When desired, the first component 14 and second component 16 can be independently adjusted and positioned.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A keyboard support panel device comprising:
a plate having a first component and a second component, said first component being selectively disconnectable from said second component;
a first adjustable arm having a first end coupled to said first component;
a first clamp coupled to a second end of said first adjustable arm;
a second adjustable arm having a primary end coupled to said second component; and
a second clamp coupled to a secondary end of said second adjustable arm.

2. The keyboard support panel device of claim 1, wherein said first adjustable arm comprises:
a first segment, said first segment being coupled to and extending from said first clamp,
a second segment, said second segment being pivotable relative to said first segment,
a third segment, said third segment being pivotable relative to said second segment,
a ball joint coupled to said third segment and said first component of said plate 3. The keyboard support panel device of claim wherein said first adjustable arm comprises a first arm swivel joint positioned in said first segment.

4. The keyboard support panel device of claim 2, further comprising said first arm swivel joint being positioned adjacent to said second segment.

5. The keyboard support panel device of claim 2, further comprising a first arm pivot plate, said first segment being pivotably coupled to said first arm pivot plate, said second segment being pivotably coupled to said first arm pivot plate

6. The keyboard support panel device of claim 1, wherein said second adjustable arm comprises:
a first section, said first section being coupled to and extending from said second clamp;
a second section, said second section being pivotable relative to said first section,
a third section, said third section being pivotable relative to said second section; and
a ball joint coupled to said third section and said first section of said plate.

7. The keyboard support panel device of claim 6, further comprising a second arm swivel joint positioned in said first section.

8. The keyboard support panel device of claim 7, further comprising said second arm swivel joint being positioned adjacent to said second section.

9. The keyboard support panel device of claim 6, further comprising a second arm pivot plate, said first section being pivotably coupled to said second arm pivot plate, said second section being pivotably coupled to said second arm pivot plate.

10. The keyboard support panel device of claim 1, further comprising a plurality of magnets positioned in said plate, said magnets releasably coupling said first component to said second component.

11. A keyboard support panel device comprising:
a plate having a first component and a second component, said first component being selectively disconnectable from said second component;
a plurality of magnets positioned in said plate, said magnets releasably coupling said first component to said second component;
a first adjustable arm having a first end coupled to said first component;
a first clamp coupled to a second end of said first adjustable arm;
a second adjustable arm having a primary end coupled to said second component;
a second clamp coupled to a secondary end of said second adjustable arm;
wherein said first adjustable arm includes
a first segment, said first segment being coupled to and extending from said first clamp,
a second segment, said second segment being pivotable relative to said first segment,
a third segment, said third segment being pivotable relative to said second segment,
a first arm ball joint coupled to said third segment and said first component of said plate
a first arm swivel joint positioned in said first segment, said first arm swivel joint being positioned adjacent to said second segment,
a first arm pivot plate, said first segment being pivotably coupled to said first arm pivot plate, said second segment being pivotably coupled to said first arm pivot plate; and
wherein said second adjustable arm includes
a first section, said first section being coupled to and extending from said second clamp,
a second section, said second section being pivotable relative to said first section,
a third section, said third section being pivotable relative to said second section,
a second arm ball joint coupled to said third section and said second component of said plate,
a second arm swivel joint positioned in said first section, said second arm swivel joint being positioned adjacent to said second section, and
a second arm pivot plate, said first section being pivotably coupled to said second arm pivot plate, said second section being pivotably coupled to said second arm pivot plate.
